(19) United States
(12) Patent Application Publication
(10) Pub. No.: US 2024/0351425 A1
(43) Pub. Date: Oct. 24, 2024

(54) Drivetrain for a Vehicle, and Vehicle

(71) Applicant: ZF Friedrichshafen AG, Friedrichshafen (DE)

(72) Inventors: Fabian Kutter, Kressbronn (DE); Matthias Horn, Tettnang (DE); Stefan Beck, Eriskirch (DE); Johannes Kaltenbach, Friedrichshafen (DE); Thomas Martin, Weissensberg (DE); Michael Wechs, Weissensberg (DE); Uwe Griesmeier, Markdorf (DE)

(21) Appl. No.: 18/682,288

(22) PCT Filed: Jul. 7, 2022
(86) PCT No.: PCT/EP2022/068903

§ 371 Date: Feb. 8, 2024

(30) Foreign Application Priority Data
Aug. 9, 2021 (DE) 10 2021 208 645.4

(51) Int. Cl. B60K 6/442; B60K 6/365; B60K 6/52; B60K 6/547

(52) U.S. Cl. CPC B60K 6/442; B60K 6/365; B60K 6/52; B60K 6/547

(57) ABSTRACT

A drive train for a vehicle includes an internal combustion engine coaxial to a first axis, a first electric machine, and a second electric machine. The first electric machine has larger dimensions than the second electric machine. The second electric machine is connectable to the internal combustion engine. A rotor axis of the first electric machine is axially offset from a rotor axis of the second electric machine. Additionally, the drive train includes a transmission arrangement connectable to a drive output, with the first electric machine being connectable to the transmission arrangement.

### CROSS-REFERENCE TO RELATED APPLICATION

The present application is related and has right of priority to German Patent Application No. 10 2021 208 645.4 filed on Aug. 9, 2021 and is a nationalization of PCT/EP2022/068903 filed in the European Patent Office on Jul. 7, 2022, both of which are incorporated by reference in their entirety for all purposes.

### FIELD OF THE INVENTION

The present invention relates generally to a drive train for a vehicle. The invention further relates generally to a vehicle which includes the drive train.

### BACKGROUND

Drive trains for vehicles are known in automotive engineering, which include an internal combustion engine and two electric machines which are associated with the same axis. Furthermore, a multi-stage transmission arrangement is provided, which is connected to a drive output. The electric machines, viewed axially, are arranged in succession behind the internal combustion engine and a torsion damper. A superposition gear set is located between the electric machines. One of the electric machines has considerably smaller dimensions, particularly a considerably smaller outer diameter, and acts as a starter generator for the internal combustion engine, while the other electric machine has considerably larger dimensions and acts as a vehicle drive system.

It has been shown that electric machines which act as a vehicle drive system require a large amount of installation space, since they require considerable dimensions with respect to their outer diameter and their axial length. Consequently, the electric machines acting as a vehicle drive system are arranged as close as possible to the internal combustion engine, since this is where the greatest amount of installation space is available. A coaxial arrangement of the electric machine is considerably limited with respect to the amount of installation space required.

### SUMMARY OF THE INVENTION

The present invention provides a drive train and a vehicle of the type described at the outset, in which the electric machines are arranged in a manner which is as favorable as possible with respect to installation space.

The invention therefore relates to a drive train for a vehicle, the drive train including an internal combustion engine which is coaxial to a first axis. The drive train also includes at least one first electric machine and one second electric machine, wherein the first electric machine is larger with respect to its dimensions and thus is suitable for use as a vehicle drive system, and the second electric machine has smaller dimensions and thus is suitable for use as a starter generator for the internal combustion engine. In addition, a multi-stage transmission arrangement is provided, the multi-stage transmission arrangement being connectable to a drive output. Moreover, it is provided with respect to the drive train that the second electric machine is connectable at least to the internal combustion engine, and the first electric machine is connectable at least to the transmission arrangement. In order to arrange the differently dimensioned electric machines in the drive train according to the invention in a manner which is as favorable as possible with respect to installation space, according to the invention, the first electric machine and the second electric machine are axially offset with respect to one another in terms of their rotor axes.

In the drive train according to the invention, the second electric machine, which has the smaller dimensions, is therefore arranged as close as possible to the internal combustion engine compared to the first electric machine which has the larger dimensions. Due to the axially offset arrangement of the two electric machines, the available installation space is usable in an optimal manner.

Within the scope of the axially offset arrangement of the electric machines, when the second electric machine is coaxial to the first axis and the first electric machine is coaxial to a second axis, with the first axis and the second axis being axially offset, more radial installation space is available for the first electric machine, for example, in the vehicle tunnel, for example, in a vehicle having a front longitudinal installation position of the prime mover. The axial offset is selected such that the outer diameter of the electric machines is selected to be as large as possible and, at the same time, sufficient underbody ground clearance remains in the vehicle.

According to an alternative axially offset arrangement of the electric machines, the second electric machine is arranged coaxially to a fourth axis, wherein the fourth axis is axially offset with respect to the first axis, where the first axis corresponds, for example, to the crankshaft axis of the internal combustion engine, and with respect to the second axis, where the second axis corresponds, for example, to the rotor axis of the first electric machine. Due to this type of axially parallel or offset arrangement of the rotor axis of the second electric machine with respect to the rotation axes of the internal combustion engine and of the first electric machine, an alternative utilization of the available installation space is realized due to such radially outward arrangement or position of the second electric machine, such that additional installation space is available for the first electric machine.

In this alternative axially parallel or offset arrangement, it is also provided that a rotor of the second electric machine is connectable to the internal combustion engine via a flexible traction drive mechanism, via multiple engaged gears or gear wheels, or the like, in order to connect the second electric machine.

In order to connect the second electric machine(s) to the transmission arrangement, which is in the form of a shiftable transmission, in the drive train according to the invention, the second electric machine is connectable via a shaft, which is coaxial to the first axis, to a first transmission input shaft of the transmission arrangement, which is coaxial to the second axis, without a reversal of the direction of rotation from the direction of rotation of the second electric machine. This connection is independent of whether the second electric machine is arranged with its rotor axis coaxially to the first axis or to the fourth axis. For example, the connection is realized without a reversal of the direction of rotation by a driving tooth system, or the like. For this purpose, a tooth system on the shaft which is coaxial to the first axis is fixedly engaged with a tooth system on the first transmission input shaft. Specifically, the tooth systems are realized, for example, by an outer tooth system on a pinion of the shaft which is coaxial to the first axis and by an inner tooth system on a ring gear or the like of the first transmission input shaft, the outer tooth system and the inner tooth system being engaged with one another. Other connections which are realized in a structurally simple manner without a reversal of the direction of rotation are also conceivable.

With respect to the transmission arrangement, various types of transmissions are usable. For example, a planetary transmission, a countershaft transmission, or even a combination thereof are usable. In this context, various arrangements of the drive output are also realized. For example, in some instances, the drive output is coaxial to the first axis, i.e., for example, coaxial to the crankshaft axis of the internal combustion engine, or, in some instances, axially offset with respect to the first axis. With respect to the arrangement of the planetary transmission or of the countershaft transmission, in the drive train according to the invention, a coaxial orientation or even an axially offset orientation with respect to the driven end are implementable.

In the drive train according to the invention, the first electric machine, which has the larger dimensions, is preferably provided or usable as a vehicle drive system, since greater power is applicable by the first electric machine. The second electric machine in the drive train according to the invention has smaller dimensions than the first electric machine and is therefore preferably used as a starter generator, i.e., for starting the internal combustion engine, and/or as a generator. It is possible, however, that the second electric machine is used during the driving operation for increasing power in certain driving situations.

In order to achieve a purely electric driving operation with the drive train according to the invention, in which at least the first electric machine or even the second electric machine are usable to drive the vehicle, according to the invention, the internal combustion engine is decouplable from the drive train via a shift element, for example, a clutch.

The drive train according to the invention optionally includes an all-wheel transfer gearbox which is connected downstream from the drive output, in order to realize all-wheel drive in the vehicle.

One further aspect of the present invention relates to a vehicle which includes the above-described drive train which is oriented in the vehicle longitudinal direction, such that the above-described advantages and further advantages result. A front longitudinal installation position of the internal combustion engine is therefore realized in the vehicle according to the invention.

### BRIEF DESCRIPTION OF THE DRAWINGS

The present invention is explained in greater detail in the following with reference to the drawings, wherein:

FIG. 1 shows a schematic view of a first embodiment of a drive train according to the invention including axially offset electric machines and including a drive and a drive output which are coaxial;

FIG. 2 shows a schematic view of a second embodiment of the drive train according to the invention including axially offset electric machines and including a drive and a drive output which are axially offset;

FIG. 3 shows a schematic view of a third embodiment of the drive train according to the invention having an alternatively axially offset arrangement of the electric machines with respect to FIG. 2;

FIG. 4 shows a schematic view of a fourth embodiment of the drive train according to the invention including a planetary transmission as the transmission arrangement having an arrangement which is axially offset with respect to the drive; and

FIG. 5 shows a schematic view of a fifth embodiment of the drive train according to the invention including a planetary transmission as the transmission arrangement having an arrangement which is coaxial with respect to the drive and the drive output.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

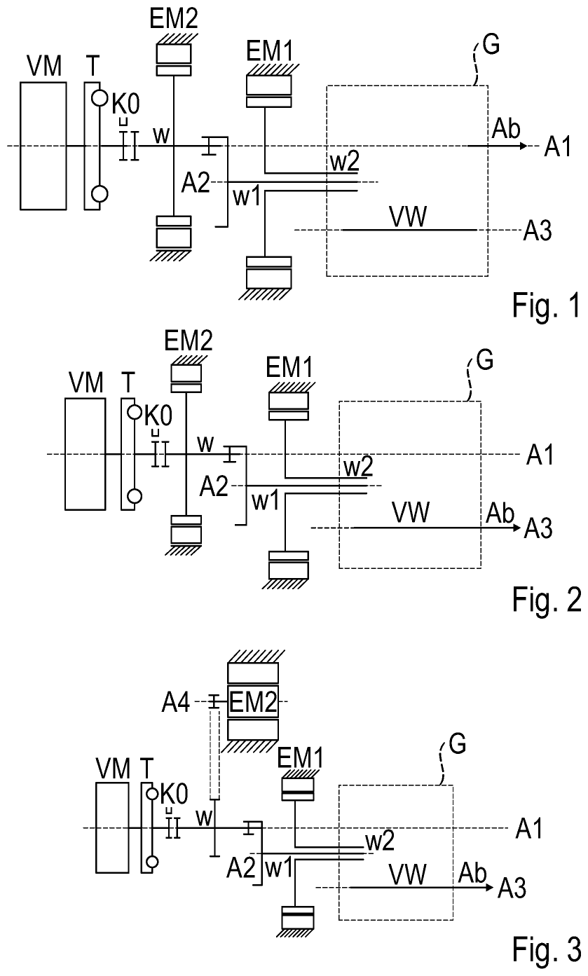

FIGS. 1-5 show various embodiments of a drive train according to the invention in a vehicle merely by way of example. The various embodiments differ with respect to individual arrangement embodiments of individual transmission components. It is possible to transfer arrangement embodiments in one embodiment to other embodiments, such that the various embodiments are combinable with one another.

With respect to the described connections between transmission components, the term “connectable” is used, which claims both a separable connection and a permanent connection. Moreover, the selected term also claims a direct connection or an indirect connection established via further components.

Regardless of the various embodiments, it is provided with respect to the drive train according to the invention that an internal combustion engine VM is coaxial to a first axis A1, which corresponds to the crankshaft axis of the internal combustion engine VM in the figures. Furthermore, a first electric machine EM1 and a second electric machine EM2 are provided, wherein the first electric machine EM1 has larger dimensions than the second electric machine EM2. This means, the first electric machine EM1 has higher power and therefore a larger outer diameter than the second electric machine EM2. Consequently, the first electric machine EM1 is preferably or exclusively used for the vehicle drive system and the second electric machine EM2 is preferably or exclusively used to start the internal combustion engine VM and as a generator. Therefore, the second electric machine EM2 is connectable at least to the internal combustion engine VM and the first electric machine EM1 is connectable at least to the transmission arrangement G. For example, a shiftable multi-stage transmission which is connectable to a drive output Ab is the transmission arrangement G.

In order to realize an arrangement of the electric machines EM1, EM2 which is as favorable as possible with respect to installation space, according to the invention, a rotor axis of the first electric machine EM1 and a rotor axis of the second electric machine EM2 are axially offset with respect to one another. The axial offset or the axially parallel arrangement of the two electric machines EM1, EM2 results in more radial installation space being available in the vehicle tunnel for the first electric machine EM1 which has larger dimensions.

In all embodiments, apart from the third embodiment according to FIG. 3, the second electric machine EM2 is coaxial to the first axis A1. Moreover, in all embodiments, the first electric machine EM1 is coaxial to a second axis A2, wherein the first axis A1 and the second axis A2 are axially offset.

In contrast thereto, in the third embodiment according to FIG. 3, according to the invention, the second electric machine EM2 is coaxial to a fourth axis A4, wherein the fourth axis A4 is axially offset with respect to the first axis A1 and with respect to the second axis A2. In the third embodiment, in order to create a driving connection between the rotor of the second electric machine EM2 and a shaft W which is coaxial to the first axis A1, a flexible traction drive mechanism is shown, for example, as a chain drive in FIG. 3. In this way, the rotor of the second electric machine EM2 is connectable to the internal combustion engine VM via the shaft W and an optionally provided clutch K0.

In all embodiments, according to the invention, the second electric machine EM2 is connectable via the shaft W which is coaxial to the first axis A1 to a first transmission input shaft W1 of the transmission arrangement G, the first transmission input shaft W1 being coaxial to the second axis A2, without a reversal of the direction of rotation between the shaft W and the first transmission input shaft W1. For this purpose, it is provided in FIGS. 1-5 that the axial offset between the two electric machines EM1, EM2 is realized via a multiplication device which does not result in a reversal of the speed direction or, in other words, a reversal of the direction of rotation between the first axis A1 and the second axis A2. As is shown in the figures, a connection is provided for this purpose, by way of example, between an outer toothing on a pinion of the shaft W which is coaxial to the first axis A1 and an inner toothing on a ring gear on the first transmission input shaft W1.

For connecting the first electric machine EM1 to the transmission arrangement, it is provided in the embodiments, by way of example, that the rotor of the first electric machine EM1 is connectable to a second transmission input shaft W2 of the transmission arrangement G, the second transmission input shaft W2 being coaxial to the second axis A2.

As is shown in FIGS. 1-3 by way of example, the transmission arrangement G has at least one countershaft VW which is coaxial to a third axis A3, the third axis A3 being axially offset with respect to the first axis A1, with respect to the second axis A2, and, if necessary, such as according to the third embodiment, with respect to the fourth axis A4.

In the first embodiment according to FIG. 1, in addition, the drive output Ab is coaxial to the first axis A1, such that the drive (the crankshaft axis of the internal combustion engine VM) and the drive output are coaxial to one another, whereas, in the second and the third embodiments according to FIGS. 2 and 3, the drive output Ab is coaxial to the third axis A3 of the transmission arrangement G.

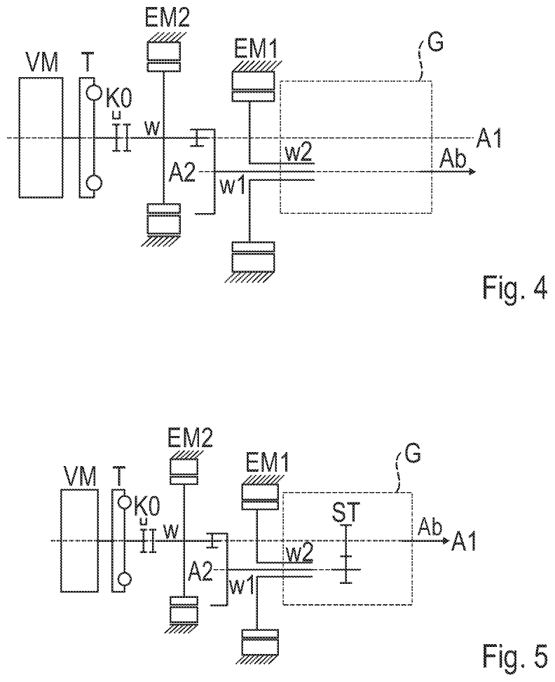

In the fourth and fifth embodiments according to FIGS. 4 and 5, a planetary transmission is the transmission arrangement G. In the fourth embodiment according to FIG. 4, the planetary transmission and the drive output Ab are coaxial to the second axis A2, the second axis A2 being axially offset with respect to the first axis A1. In the fifth embodiment according to FIG. 5, according to the invention, the planetary transmission and the drive output Ab are coaxial to the first axis A1, the planetary transmission being connectable via at least one spur gear stage ST to the first and the second transmission input shafts W1, W2 which are coaxial to the second axis A2.

In all embodiments, it is shown in the figures, by way of example, that the second electric machine EM2, viewed axially, is arranged ahead of the first electric machine EM1 relative to the internal combustion engine VM and that the first electric machine EM1, viewed axially, is arranged ahead of the transmission arrangement G relative to the internal combustion engine VM. As a result, in the axial direction starting from the internal combustion engine VM, the second electric machine EM2 is arranged first, followed by the first electric machine EM1, which is followed by the transmission arrangement G with the drive output Ab. Furthermore, a torsional vibration damper T is connected downstream from the internal combustion engine VM, the torsional vibration damper T being connectable via a shift element K0 to the shaft W which is coaxially associated with the first axis A1.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

EM1 first, larger-dimensioned, electric machine
EM2 second, smaller-dimensioned, electric machine
VM internal combustion engine
A1 first axis or crankshaft axis
A2 second axis
A3 third axis
A4 fourth axis
Ab drive output
G multi-stage transmission arrangement
W shaft coaxial to the first axis
W1 first transmission input shaft
W2 second transmission input shaft
VW countershaft
K0 clutch
T torsional vibration damper
ST spur gear stage

1 through 17. (canceled)

18. A drive train for a vehicle, comprising:
an internal combustion engine (VM) coaxial to a first axis (A1);
a first electric machine (EM1);
a second electric machine (EM2), the first electric machine (EM1) having larger dimensions than the second electric machine (EM2), the second electric machine (EM2) being connectable to the internal combustion engine (VM), a rotor axis of the first electric machine (EM1) being axially offset from a rotor axis of the second electric machine (EM2); and
a transmission arrangement (G) connectable to a drive output (Ab), the first electric machine (EM1) being connectable to the transmission arrangement (G).

19. The drive train of claim 18, wherein the rotor axis of the second electric machine (EM2) is coaxial to the first axis (A1),
wherein the rotor axis of the first electric machine (EM1) is coaxial to a second axis (A2), and
wherein the first axis (A1) is axially offset from the second axis (A2).

20. The drive train of claim 18, wherein the rotor axis of the first electric machine (EM1) is coaxial to a second axis (A2), and
wherein the rotor axis of the second electric machine (EM2) is coaxial to a fourth axis (A4), the fourth axis (A4) being axially offset from the first axis (A1) and the second axis (A2).

21. The drive train of claim 20, wherein a rotor of the second electric machine (EM2) is connectable to the internal combustion engine (VM) via a flexible traction drive mechanism or via multiple engaged gear wheels.

22. The drive train of claim 18, further comprising a shaft (W) coaxial to the first axis (A1),
wherein the rotor axis of the first electric machine (EM1) is coaxial to a second axis (A2),
wherein the transmission arrangement (G) includes a first transmission input shaft (W1) and a second transmission input shaft (W2), the first transmission input shaft (W1) and the second transmission input shaft (W2) being coaxial to the second axis (A2),
wherein the second electric machine (EM2) is connectable via the shaft (W) to the first transmission input shaft (W1) of the transmission arrangement (G), without a reversal of a direction of rotation from the shaft (W) at the first transmission input shaft (W1), and
wherein a rotor of the first electric machine (EM1) is connectable to the second transmission input shaft (W2) of the transmission arrangement (G).

23. The drive train of claim 18, wherein the rotor axis of the first electric machine (EM1) is coaxial to a second axis (A2), and
wherein the transmission arrangement (G) has at least one countershaft (VW) coaxial to a third axis (A3), the third axis (A3) being axially offset from the first axis (A1) and the second axis (A2).

24. The drive train of claim 23, wherein the rotor axis of the first electric machine (EM1) is coaxial to a second axis (A2), and
wherein the rotor axis of the second electric machine (EM2) is coaxial to a fourth axis (A4), the fourth axis (A4) being axially offset from the first axis (A1) and the second axis (A2), and
wherein the third axis (A3) is axially offset from the fourth axis (A4).

25. The drive train of claim 23, wherein the drive output (Ab) is coaxial to the first axis (A1).

26. The drive train of claim 23, wherein the drive output (Ab) is coaxial to the third axis (A3) of the transmission arrangement (G).

27. The drive train of claim 18, wherein the transmission arrangement is a planetary transmission.

28. The drive train of claim 27, wherein the rotor axis of the first electric machine (EM1) is coaxial to a second axis (A2), and
wherein the planetary transmission and the drive output (Ab) are coaxial to the second axis (A2), the second axis (A2) being axially offset from the first axis (A1).

29. The drive train of claim 27, further comprising at least one spur gear stage (ST),
wherein the rotor axis of the first electric machine (EM1) is coaxial to a second axis (A2),
wherein the transmission arrangement (G) includes a first transmission input shaft (W1) and a second transmission input shaft (W2), the first transmission input shaft (W1) and the second transmission input shaft (W2) being coaxial to the second axis (A2),
wherein the planetary transmission and the drive output (Ab) are coaxial to the first axis (A1), the planetary transmission being connectable via the at least one spur gear stage (ST) to the first transmission input shaft (W1) and the second transmission input shaft (W2).

30. The drive train of claim 18, wherein the second electric machine (EM2) is axially closer to the internal combustion engine (VM) than the first electric machine (EM1), and the first electric machine (EM1) is axially closer to the internal combustion engine (VM) than the transmission arrangement (G).

31. The drive train of claim 18, wherein the first electric machine (EM) is a vehicle drive system, and the second electric machine (EM2) is at least one of a starter for the internal combustion engine (VM) or a generator.

32. The drive train of claim 18, further comprising a torsional vibration damper (T) connected downstream from the internal combustion engine (VM).

33. The drive train of claim 18, further comprising:
a shaft (W) coaxial to the first axis (A1); and
a shift element (K0), the internal combustion engine (VM) being decouplable via the shift element (K0) from the shaft (W).

34. The drive train of claim 18, further comprising an all-wheel transfer gearbox is connected downstream from the drive output (Ab).

35. A vehicle comprising the drive train of claim 18, the drive train being oriented in a vehicle longitudinal direction.
